(19) United States
(12) Patent Application Publication
(10) Pub. No.: US 2025/0392405 A1
(43) Pub. Date: Dec. 25, 2025

(54) METHOD AND APPARATUS FOR ROBUST SMALL DATA TRANSMISSION IN A WIRELESS NETWORK

(71) Applicant: Continental Automotive Technologies GmbH, Hannover (DE)

(72) Inventors: Rikin Shah, Langen (DE); David Gonzalez Gonzalez, Egelsbach (DE); Reuben George Stephen, Singapore (SG)

(73) Assignee: Continental Automotive Technologies GmbH, Hannover (DE)

(21) Appl. No.: 18/881,405

(22) PCT Filed: Jul. 20, 2023
(86) PCT No.: PCT/EP2023/066593

§ 371 Date: Jan. 6, 2025

(30) Foreign Application Priority Data
Jul. 6, 2022 (DE) 10 2022 206 907.2

(51) Int. Cl. H04L 1/00; H04W 68/00

(52) U.S. Cl. CPC H04L 1/0005; H04L 1/0026; H04W 68/005

(57) ABSTRACT

Robust Small Data Transmissions are performed from a base station to a user equipment of a wireless communication network while user equipment is in an Inactive state. A user equipment: receives a paging notification from a base station while in an inactive state, performs signal quality measurement, sends a message including at least a channel quality indication to the base station in response to the received paging notification, and receives a message from the base station including downlink data. The message is transmitted using a modulation scheme selected by the base station based on the reported channel quality indication.

### CROSS-REFERENCE TO RELATED APPLICATIONS

The present application is a National Stage Application under 35 U.S.C. § 371 of International Patent Application No. PCT/EP2023/066593 filed on Jun. 20, 2023, and claims priority from German Patent Application No. 10 2022 206 907.2 filed on Jul. 6, 2022, in the German Patent and Trademark Office, the disclosures of which are herein incorporated by reference in their entireties.

### TECHNICAL FIELD

The application generally relates to wireless communications and, more particularly, to apparatuses and methods for Small Data Transmission (SDT) in a Radio Resource Control (RRC) inactive state.

### BACKGROUND

Because transitioning from a RRC Inactive or RRC idle state to a RRC connected state might cause overheads for a UE when only a small amount of data is to be transmitted, 3rd Generation Partnership Project (3GPP) has introduced technologies to optimize such small packets transmission. Indeed, UE needs to exchange multiple control signals to initiate and maintain a connection with a network. When payload size is relatively small compared with the amounts of the control signals, establishing a connection becomes a concern for both the network and UE due to control signaling overhead.

Small Data Transmission (SDT) in RRC Inactive state has been introduced in 3GPP Release 17 for 5G NR to reduce signaling overhead and UE power consumption for infrequent data transmission. It allows UEs to transmit sporadic and small amount of data in RRC Inactive state, without requiring an RRC state transition.

The RRC Inactive state was introduced so as to keep the AS (Access Stratum) context at the base station and UE, with the aim of reducing energy consumption and the number of messages exchanged between a user equipment and a base station. In the RRC Inactive state, the user equipment and the base station suspend their radio connection, but the AS context is preserved in the user equipment and the base station.

Two types of SDT have been defined by 3GPP depending on how radio resources are configured: SDT using a random access (RA-SDT) and SDT using preConfigured Grant (CG-SDT). RACH (Random Access CHannel) based SDT allows SDT using an uplink grant received via a random access procedure for SDT. CG based SDT allows SDT from an RRC inactive state using a configured grant without performing a random access procedure.

Small Data Transmission using the preconfigured radio resource is referred to as transmission via PUR (Preconfigured Uplink Resource) in the LTE standards and CG-SDT (Configured Grant based SDT) in 5G NR standard. The base station configures radio resources when transiting the user equipment from RRC connected to RRC inactive state, for example in a RRC Release message including radio resource configuration for PUR of CG-SDT.

Small Data Transmission using the random access is referred to as an EDT (early data transmission) in LTE standard and RA-SDT (Random Access based SDT) in 5G NR (New Radio) standard. Data is transmitted using shared radio resources of the random access procedure.

Basically, when a base station needs to send a small amount of data to a user equipment in RRC Inactive state, it sends a paging notification to the user equipment. Such paging message is sent in SSB (Signal Synchronization Block) using QPSK (Quaternary Phase Shift Keying) modulation for Physical Downlink Control Channel (PDCCH), making it possible for the user equipment to decode the message even in low RSRP (Reference Signal Received Power) conditions. However, actual downlink data transmission may not be carried over a QPSK modulation and could be subject to errors in low RSRP conditions, leading to packets retransmissions and overheads.

Therefore, there is a need for a robust way of transmitting Small Data in RRC inactive state.

### BRIEF SUMMARY

In one aspect, it is proposed a method for receiving Small Data Transmission (SDT) by a user equipment device connected to a wireless communication network. The method comprises acts of:
Receiving a paging notification from a base station while in inactive state,
Performing signal quality measurement,
Sending a message comprising at least a channel quality indication report to said base station in response to the received paging notification, and
Receiving a message from the base station comprising downlink data, said message being transmitted using a modulation scheme selected by said base station on the basis of said reported channel quality indication.

Upon receiving a paging message from a base station indicating that downlink data is available, a user equipment may thus perform a channel quality measure and transmit a channel quality report to the base station, for example a CQI Index as defined by 3GPP. Using said channel quality indicator, a base station may then select and use the most suitable modulation scheme to transmit data over said channel. This way, transmission errors may be reduced, and retransmissions may be avoided, limiting signaling overhead and power consumption.

According to an embodiment, the signal quality indication is reported in a msg3 message, and downlink data are received in a msg4 message.

The disclosure thus contemplates that a user equipment sends a Channel Quality Indication in a Msg3 message, together with a RRC Resume request message. The base station serving the UE may then select MCS (Modulation and Coding Scheme) based on said Channel Quality Indication when sending Small Data Amount in Msg4.

According to an embodiment, the signal quality indication is reported in a msgA message and downlink data are received in a msgB message.

In order to reduce latency and signaling overhead, 3GPP introduced two-step Random Access Procedure. This is achieved by combining the Random Access preamble (Msg1) and the scheduled PUSCH transmission (Msg3) into a single MsgA message from the UE, and by combining the random-access response Msg2 and the contention resolution message Msg4 into a single message MsgB from the base station to user equipment.

Hence, the present disclosure contemplates that a user equipment sends the Channel Quality Indication in a MsgA message, together with Random Access Preamble. Downlink data may then be received in a MsgB message using a MCS selected based on the channel quality indication sent to the base station in MsgB message. Such a provision is particularly relevant in EDT (Early Data Transmission) or RA-SDT (Random Access-small Data Transmission) situation.

According to an embodiment, the signal quality indication is reported on a Physical Uplink Shared Channel (PUSCH) using a resource grant configured by the base station prior entering RRC Inactive state.

It is thus proposed that a user equipment sends a Channel Quality indication to a base station over a PUSCH (Physical Uplink Shared Channel) when a resource grant is preconfigured, for example in case of PUR or CG-SDT.

According to an embodiment, the method comprises a step of receiving a message comprising initial downlink data from the base station prior reporting channel quality indication, wherein said initial downlink data are transmitted using a preconfigured low modulation scheme.

It is proposed that a first downlink small data burst is always transmitted using a low modulation scheme, like QPSK, to limit the risk of transmission errors, even in poor radio conditions.

According to an embodiment, the message sent in response to the received paging notification further comprises at least one neighboring beam indication.

Based on such information, a base station may duplicate downlink data transmission in more than one beam. The transmission is thus more robust.

The present disclosure also relates to an apparatus for receiving Small Data Transmission (SDT) from a base station in a wireless communication network, comprising a processor coupled with a memory in which computer program instructions are stored, said instructions being configured to perform the following acts, when executed by said processor:
Receiving a paging notification from a base station while in inactive state, Performing signal quality measurement,
Sending a message comprising at least a channel quality indication report to said base station in response to the received paging notification, and
Receiving a message from the base station comprising downlink data, said message being transmitted using a modulation scheme selected by said base station on the basis of said reported channel quality indication.

The present disclosure also relates to a user equipment comprising an apparatus for receiving Small Data Transmission (SDT) from a base station as described above.

Another aspect of the disclosure relates to a method for sending Small Data Transmission by a base station of a wireless communication network, the method comprising:
Sending a paging notification to a user equipment,
Receiving a response message to said paging notification, the message comprising at least a radio signal quality indicator report measured by said user equipment,
Transmitting a message comprising downlink data to said user equipment, said message being transmitted using a modulation scheme selected according to said received radio signal quality indicator.

According to an embodiment, the signal quality indication is received in a msgA message and downlink data is sent in a msgB message.

According to an embodiment, the signal quality indication is received in a msg3 message, and downlink data is sent in a msg4 message.

According to an embodiment, the signal quality indication is received on a Physical Uplink Shared Channel (PUSCH) using a resource grant configured prior entering RRC Inactive state.

According to an embodiment, the method comprises transmitting Small Data on at least two beams when said message received in response to the paging notification further comprises at least a neighboring beam indication.

The disclosure also relates to an apparatus for transmitting Small Data Transmission (SDT) to a user equipment in a wireless communication network, comprising a processor coupled with a memory in which computer program instructions are stored, said instructions being configured to perform the following acts, when executed by said processor:
Sending a paging notification to a user equipment,
Receiving a response message to said paging notification, the message comprising at least a radio signal quality indicator report measured by said user equipment,
Transmitting a message comprising downlink data to said user equipment, said message being transmitted using a modulation scheme selected according to said received radio signal quality indicator.

The disclosure is also related to a base station comprising an apparatus for transmitting Small Data Transmission (SDT) from a base station as described above.

System for performing Small Data Transmission in a wireless network comprising a base station and a user equipment, wherein said base station comprises a processor coupled with a memory in which computer program instructions are stored, said instructions being configured to implement acts of:
Sending a paging notification to said user equipment,
Receiving a response message to said paging notification, the message comprising at least a radio signal quality indicator report measured by said user equipment,
Transmitting a message comprising downlink data to said user equipment, said message being transmitted using a modulation scheme selected according to said received radio signal quality indicator, and
wherein said user equipment comprises a processor coupled with a memory in which computer program instructions are stored, said instructions being configured to implement acts of:
Receiving a paging notification from a base station while in inactive state, Performing signal quality measurement,
Sending a message comprising at least a channel quality indication report to said base station in response to the received paging notification, and
Receiving a message from the base station comprising downlink data, said message being transmitted using a modulation scheme selected by said base station on the basis of said reported channel quality indication.

In some embodiments, the various steps of the method for receiving Small Data Transmission by a user equipment and/or the method for sending Small Data Transmission by a base station are determined by instructions of computer programs.

Consequently, the disclosure further contemplates computer programs on an information medium, these programs being suitable to be implemented respectively in user equipment device and a base station, or more generally in a computer, these programs respectively comprising instructions adapted to implement the steps of the wireless communication methods respectively supported by a user equipment and performed by a base station disclosed herein.

These programs can use any programming language, and be in the form of source code, object code, or of code intermediate between source code and object code, such as in a partially compiled form, or in any other desirable form.

A further aspect contemplates an information medium readable by a computer comprising instructions of a computer program such as mentioned hereinabove.

The information medium may be any entity or device capable of storing the program. For example, the medium can comprise a storage means, such as a ROM, for example a CD ROM or a microelectronic circuit ROM, EEPROM, FLASH memory or any magnetic recording means, for example a hard drive.

Moreover, the information medium may be a transmissible medium such as an electrical or optical signal, which may be conveyed via an electrical or optical cable, by radio or by other means. The program according to an embodiment of the invention may in particular be downloaded from a network.

Alternatively, the information medium may be an integrated circuit into which the program is incorporated, the circuit being arranged to execute or to be used in the execution of the methods in question.

The advantages of apparatus, user equipment, base station, system, and corresponding computer programs and information mediums are identical to those presented in relation with the method for receiving Small Data according to any one of the embodiments mentioned hereinabove.

### BRIEF DESCRIPTION OF THE DRAWINGS

Other advantages and characteristics of the invention will be more clearly apparent on reading the following description, given by way of simple illustrative and nonlimiting example, and the appended drawings.

FIG. 1 illustrates a wireless system comprising a user equipment and a base station in which aspects of the present disclosure may be practiced.

FIG. 2 is a diagram illustrating a UE-terminated small data transmission example in RRC Inactive state, according to a first embodiment.

FIG. 3 is a diagram illustrating a UE-terminated small data transmission example in RRC Inactive state, according to a second embodiment.

FIG. 4 is a block diagram of an apparatus for receiving small data transmissions, according to an embodiment.

FIG. 5 is a block diagram of an apparatus for sending small data transmissions, according to an embodiment.

### DETAILED DESCRIPTION

The detailed description set forth below, with reference to annexed drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In particular, although terminology from 3GPP 5G NR may be used in this disclosure to exemplify embodiments herein, this should not be seen as limiting the scope of the invention.

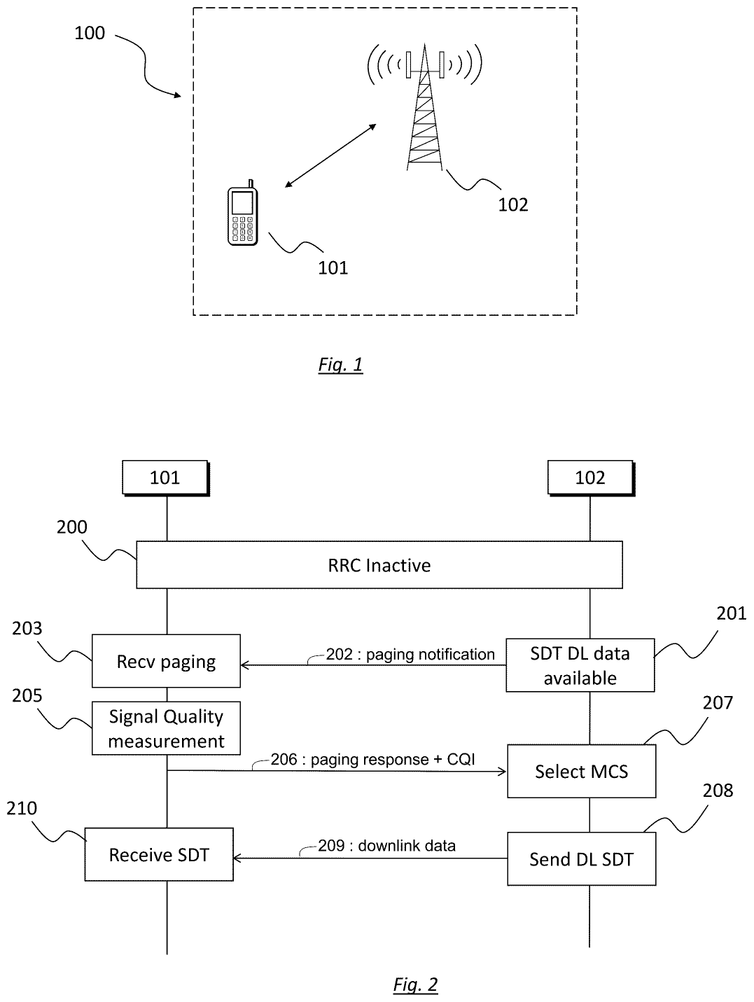

FIG. 1 shows an exemplary 5G New Radio (NR) wireless communication system 100 comprising a user equipment 101 and a base station 102 in which aspects of the present disclosure may be practiced. The wireless network 100 may be an LTE network or some other wireless network, such as LTE, 5G or NR network. The wireless network 100 may include one or more base stations 102. The base station 102 may be referred as BS, NB, eNodeB (or eNB), gNodeB (or gNB), an access point or the like, depending on the wireless standard implemented. Base station 102 provide radio communication coverage for a particular geographic area called “cell”.

User equipment 101 may be referred as a mobile station, a wireless terminal, or the like. In some examples, user equipment 101 may be a cellular phone, a wireless modem, a wireless communication device, a handheld device, a laptop computer or the like. User equipment 101 may also be an IoT (internet of things) device, like wireless camera, a smart sensor or smart meter, a vehicle, a global positioning system device, or any other device configured to communicate through a wireless network.

User equipment 101 may support various communication modes, such as a connected mode (RRC Connected), an inactive mode (RRC Inactive), or an idle mode (RRC Idle) as defined by 3GPP. When operating in RRC Connected mode, user equipment 101 is active and communicate with base station 102. User equipment 101 may transition from communication mode to another using various commands and messages received from the base station 102. For example, User equipment 101 may switch from RRC Connected state to RRC Inactive state upon receiving a RRC Release message including suspendConfig parameter.

User equipment 101 may enter RRC Inactive state without completely releasing radio resources when there is no traffic, in order to quickly switch back to RRC_Connected states when necessary. In this case, user equipment and base station may store a context for the user equipment, for example an access stratum (AS) context, in order to apply said stored context when transitioning from RRC Inactive to RRC Connected state and thus reduce latency and signaling overhead. Such context may include Radio configuration parameters, such as uplink grant, RNTI (Radio Network Temporary Identifier), MCS and/or the like.

However, radio conditions may have changed while user equipment 101 is RRC Inactive state, for example user equipment 101 may have moved to another location, thus altering channel quality.

FIG. 2 is a diagram illustrating a user equipment-terminated small data transmission example in RRC Inactive state, according to an embodiment.

During a preliminary step 200, user equipment 101 may switch to RRC inactive state in response to a RRC Release message with suspendConfig parameter. An I-RNTI (Inactive Radio Network Temporary Identifier), may be allocated to user equipment 101 within such RRC Release message as part of suspendConfig parameter.

While user equipment 101 is in RRC Inactive state, the base station 102 may receive, at step 201, downlink data destinated to user equipment 101. The downlink data may include a small amount of data like keep-alive packets, sensor data, push notifications, location data, etc., Base station 102 may transmit a paging notification 202 to user equipment 101 to inform about available downlink data, the paging notification comprising at least an identifier associated to the user equipment 101, for example a I-RNTI.

User equipment 101 may receive the paging notification 202 while in inactive at step 203. User equipment 101 may decode the received notification and compare at least an identifier associated with the user equipment 101, for example a I-RNTI, comprised in the notification with its own identifier to determine that said paging is destinated to user equipment 101.

Reception of such paging notification by the user equipment 101 triggers a step 205 of performing at least a signal quality measure. The signal quality measure may include at least determining a reference signal received power (RSRP), a received signal strength indicator (RSSI), a reference signal received quality (RSRQ), and/or a channel quality indicator (CQI).

User equipment 101 performs measurement based on the SSB (Synchronization Signal Block) resources and/or CSI-RS (Channel State Information Reference Signal) resources, whereby SSB resources are broadcasted through system information message and CSI-RS resources are configured through system information message and/or dedicated signaling message (e.g., paging message or RRC release message).

User equipment 101 transmits measurement report, for example a CQI index to the base station in a message 206. According to some embodiments, message 206 may be of MsgA type or Msg3 type, depending on Random Access (RA) procedure type (two-step RA or four-step RA).

According to an embodiment, Configured Grant (CG) resources are configured to the user equipment by the base station during transition to RRC Inactive state, so that the UE uses these CG resources to transmit CQI index on Physical Uplink Shared Channel (PUSCH) directly to the gNB without performing 2-step RA and 4-step RA.

The disclosure also contemplates that user equipment 101 may indicate one or more neighboring beam with/without CQI index in message 206. For example, user equipment 101 may provide one or more beam identifiers.

Base station 102 may receive message 206 including CQI index at step 207. Based on the received CQI Index, base station 102 may determine during step 207 an appropriate MCS to transmit pending data to user equipment 101, i.e. lower MCS for poor channel quality and higher MCS for good quality channels.

Table 1 below shows a mapping table defined by 3GPP wherein a CQI index is mapped to a specific modulation scheme.

TABLE 1

| CQI | |
|---|---|
| Index | Modulation |
| 1 | QPSK |
| 2 | QPSK |
| 3 | QPSK |
| 4 | QPSK |
| 5 | QPSK |
| 6 | QPSK |
| 7 | 16QAM |
| 8 | 16QAM |
| 9 | 16QAM |
| 10 | 64QAM |
| 11 | 64QAM |
| 12 | 64QAM |
| 13 | 64QAM |
| 14 | 64QAM |
| 15 | 64QAM |

Base station 102 may use such table to determine an appropriate MCS in response to a CQI Index transmitted by user equipment 101 in message 206.

Base station 208 may then send downlink using the MCS determined at step 207 in a message 209. According to an embodiment, message 209 may be of MsgB or Msg4 type depending on the Random Access procedure type (i.e. 2-steps or 4 steps RA).

According to an embodiment, when information regarding one or more neighboring beam is provided in message 206, base station 102 may duplicate downlink transmission in said one or more beams. Such solution reduces decoding error rate and increase reliability.

User equipment 101 may receive downlink data in message 209 at step 210. Downlink data is received using a MCS selected by the base station 102 based on CQI index transmitted by user equipment 101. Therefore, high quality data transmission may take place even is radio channel conditions have changed since user equipment 101 entered in Inactive state. This lowers the risk of retransmission and allows energy saving.

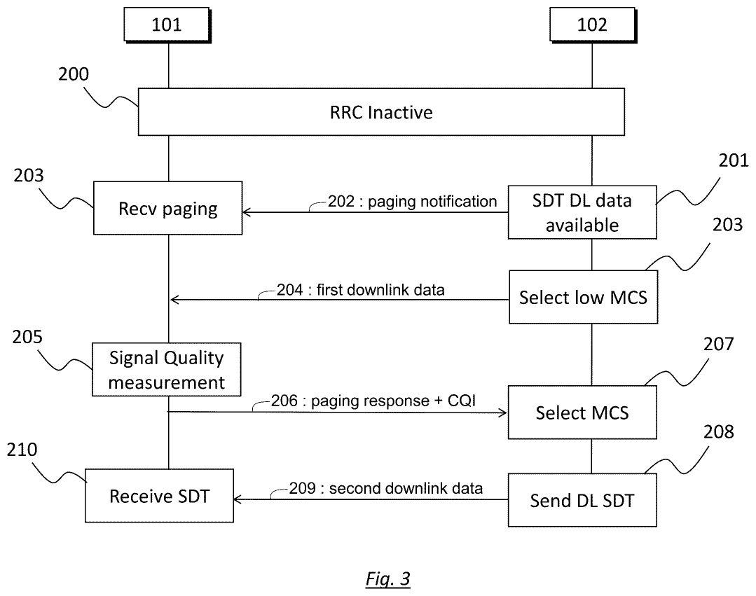

FIG. 3 is a diagram illustrating an example of a user equipment terminated small data transmission in RRC Inactive state, according to second embodiment.

As shown on FIG. 3, the second embodiment differs from the first embodiment in that the base station 102 perform a step 203 of sending an initial small data burst right after sending the paging notification 202, said initial small data burst being transmitter using a low MCS, for example QPSK. However, this initial low modulation and coding scheme may be dynamically updated by user equipment 101 by sending a channel quality indicator through message 206 as previously described. Such a provision allows a robust and low latency data transmission.

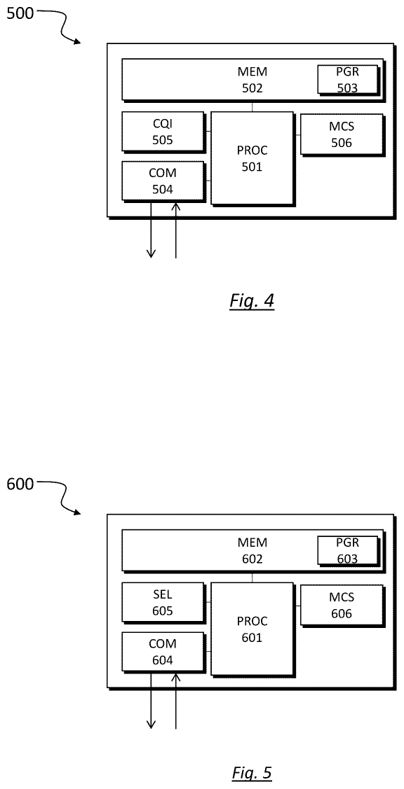

FIG. 4 is a block diagram showing a schematic architecture of an apparatus 500 suitable to implement a method of wireless communication for receiving a Small Data Transmission (SDT) from a base station, according to an embodiment.

The apparatus 500 comprises a processor 501 and a memory 502, for example a Random Access Memory (RAM). The processor 501 may be controlled by a computer program 503 stored in the memory 502 comprising instructions configured to implement a method for receiving Small Data Transmission (SDT) from a base station in a wireless communication network.

More precisely, the computer program 503 comprises instructions for triggering a signal quality measurement upon receiving a paging notification from a base station while in inactive state, sending a message comprising at least a channel quality indication to said base station in response to the received paging notification, and receiving a message from the base station comprising downlink data, said message being transmitted using a modulation scheme selected by said base station on the basis of said reported channel quality indication.

On initialization, instructions of the computer program 503 may be loaded into the memory 502 before being executed by the processor 501. The processor 501 implements the steps of the method according to the instructions of the computer program 503.

The apparatus 500 comprises a wireless communication unit 504, for example a 3G, 4G, 5G, 5G NR, WiFi or WiMax transceiver for exchanging messages with other apparatus. In particular, communication unit 504 is configured by program instructions to receive a paging notification broadcasted by a base station and check if the received paging is addressed to the apparatus by comparing an identifier comprised in said paging notification with an identifier associated with the apparatus.

Apparatus 500 further comprises a radio channel quality measurement unit 505 configured to determine a reference signal received power (RSRP), a received signal strength indicator (RSSI), a reference signal received quality (RSRQ), and/or a channel quality indicator (CQI) based on SSB (Synchronization Signal Block) resources and/or CSI-RS (Channel State Information Reference Signal). The measurement unit is further configured to report a channel quality indicator, like CQI Index, to a base station in a message (e.g. MsgA, Msg3 or on PUSCH) sent by the communication unit 504.

The apparatus 500 further comprises a demodulator unit 506. The demodulator unit 506 is configured by program instructions to demodulate and decode a small data burst received by the communication unit 504. In particular, the demodulator module 506 is configured to demodulate and decode a small data burst transmitted in a message (e.g. in MsgB, Msg4 or over PDSCH) using a modulation scheme selected by said base station based on channel quality indication determined by the measurement unit 505.

According to an embodiment, the apparatus 500 is included in a user equipment, for example a cellular phone, a tablet, a vehicle, a smart sensor and/or the like.

FIG. 5 is a block diagram showing a schematic architecture of an apparatus 600 suitable to implement a method of wireless communication for Small Data Transmission (SDT) to a user equipment, according to an embodiment.

The apparatus 600 comprises a processor 601 and a memory 602, for example a Random Access Memory (RAM). The processor 601 may be controlled by a computer program 603 stored in the memory 602 comprising instructions configured to implement a method for Small Data Transmission (SDT) to a user equipment in a wireless communication network.

More precisely, the computer program 603 comprises instructions for sending a paging notification to a user equipment when downlink data is available, receiving a response message to said paging notification, the message comprising at least a radio signal quality indicator measured by said user equipment, and transmitting a message comprising downlink data to said user equipment, said message being transmitted using a modulation scheme selected according to said received radio signal quality indicator.

On initialization, instructions of the computer program 603 may be loaded into the memory 602 before being executed by the processor 601. The processor 601 implements the steps of the method according to the instructions of the computer program 603.

The apparatus 600 comprises a wireless communication unit 604, for example a 3G, 4G, 5G, 5G NR, WiFi or WiMax transceiver for exchanging messages with other apparatus. In particular, communication unit 604 is configured by program instructions to broadcast a paging notification comprising at least an identifier of a user equipment in RRC inactive state when a small data amount is to be transmitted to said user equipment.

The wireless communication unit 604 is further configured by program instructions to receive a channel quality indicator (e.g. CQI index) transmitted by a user equipment in MsgA or Msg3 or over PUSCH in response to the paging notification.

The apparatus 600 further comprises a MCS selection unit 605. The MCS selection unit may be configured by program instructions to select a MCS based on a channel quality indicator, for example a CQI Index, received from a user equipment in response to a paging notification sent to said user equipment. The MCS selection unit is configured to select a low MCS for low CQI Indexes and a High MCS for high CQI Indexes. In some implementations, the MCS selection unit may use a table like the table shown on Table 1 to select a particular MCS for a given CQI Index.

Apparatus 600 also comprises a modulation and coding unit 606 configured by program instructions to code and modulate a small data signal according the MCS selected by selection unit 605.

According to an embodiment, the apparatus 600 is comprised in a base station, for example an eNodeB or gNodeB.

1. A method for receiving Small Data Transmission from a base station in a wireless communication network, the method comprising:
receiving a paging notification from a base station while in inactive state;
performing signal quality measurement;
sending a message comprising at least a channel quality indication report to said base station in response to the received paging notification; and
receiving a message from the base station comprising downlink data, said message being transmitted using a modulation scheme selected by said base station on the basis of said reported channel quality indication.

2. The method according to claim 1 wherein the signal quality indication is reported in a msg3 message, and downlink data are received in a msg4 message.

3. A The method according to claim 1 wherein the signal quality indication is reported in a msgA message, and downlink data are received in a msgB message.

4. A The method according to claim 1 wherein the signal quality indication is reported on a Physical Uplink Shared Channel using a resource grant configured by the base station prior to entering RRC Inactive state.

5. The method according to claim 1 further comprising receiving a message comprising initial downlink data from the base station prior to reporting channel quality indication, wherein said initial downlink data are transmitted using a preconfigured low modulation scheme.

6. The method according to claim 1 wherein the message sent in response to the received paging notification further comprises at least one neighboring beam indication.

7. An apparatus for receiving Small Data Transmission from a base station in a wireless communication network, comprising a processor coupled with a memory in which computer-executable instructions are stored, said instructions, when executed by said processor, being configured to cause performance of operations comprising:
receiving a paging notification from a base station while in inactive state;
performing signal quality measurement;
sending a message comprising at least a channel quality indication report to said base station in response to the received paging notification; and
receiving a message from the base station comprising downlink data, said message being transmitted using a modulation scheme selected by said base station on the basis of said reported channel quality indication.

8. User equipment comprising an apparatus for receiving Small Data Transmission according to claim 7.

9. A method for sending Small Data Transmission to a user equipment in a wireless communication network, the method comprising:
sending a paging notification to a user equipment,
receiving a response message to said paging notification, the message comprising at least a radio signal quality indicator report measured by said user equipment,
transmitting a message comprising downlink data to said user equipment, said message being transmitted using a modulation scheme selected according to said received radio signal quality indicator.

10. The method according to claim 9 wherein the signal quality indication is received in a msgA message, and downlink data is sent in a msgB message.

11. The method according to claim 9 wherein the signal quality indication is received in a msg3 message, and downlink data is sent in a msg4 message.

12. The method according to claim 9 wherein the signal quality indication is received on a Physical Uplink Shared Channel using a resource grant configured prior to entering RRC Inactive state.

13. The method according to claim 9 transmitting Small Data on at least two beams when said message received in response to the paging notification further comprises at least a neighboring beam indication.

14. An apparatus for transmitting Small Data Transmission to a user equipment in a wireless communication network, comprising a processor coupled with a memory in which computer-executable instructions are stored, said instructions, when executed by the processor, are configured to perform operations comprising:
sending a paging notification to a user equipment,
receiving a response message to said paging notification, the message comprising at least a radio signal quality indicator report measured by said user equipment,
transmitting a message comprising downlink data to said user equipment, said message being transmitted using a modulation scheme selected according to said received radio signal quality indicator.

15. The apparatus for transmitting Small Data Transmission according to claim 14, wherein the apparatus is a base station.

16. A system for performing Small Data Transmission in a wireless network comprising a base station and a user equipment, wherein said base station comprises a processor coupled with a memory in which computer-executable instructions are stored, said instructions being configured to, when executed by the processor cause performance of operations comprising:
sending a paging notification to said user equipment,
receiving a response message to said paging notification, the message comprising at least a radio signal quality indicator report measured by said user equipment,
transmitting a message comprising downlink data to said user equipment, said message being transmitted using a modulation scheme selected according to said received radio signal quality indicator, and
wherein said user equipment comprises a processor coupled with a memory in which computer program instructions are stored, said instructions being configured to implement acts of:
receiving a paging notification from a base station while in inactive state,
performing signal quality measurement,
sending a message comprising at least a channel quality indication report to said base station in response to the received paging notification, and
receiving a message from the base station comprising downlink data, said message being transmitted using a modulation scheme selected by said base station based on said reported channel quality indication.
